(19) United States
(12) Patent Application Publication
(10) Pub. No.: US 2013/0262159 A1
(43) Pub. Date: Oct. 3, 2013

(54) Finding Best Seating Selections via Algorithmic Search

(71) Applicants: Richard Joseph Lamprea Montero, Makati City (PH); Terry Wayne Hornbaker, Holladay, UT (US); Raelynn A. Sink, Lakeville, MN (US); Janice McReaken, Midvale, UT (US)

(72) Inventors: Richard Joseph Lamprea Montero, Makati City (PH); Terry Wayne Hornbaker, Holladay, UT (US); Raelynn A. Sink, Lakeville, MN (US); Janice McReaken, Midvale, UT (US)

(73) Assignee: Accenture Global Services Limited, Dublin (IE)

(21) Appl. No.: 13/432,570

(22) Filed: Mar. 28, 2012

(51) Int. Cl. G06Q 10/02

(52) U.S. Cl. 705/5

(57) ABSTRACT

Methods, systems, and apparatus, including computer programs encoded on a computer storage medium, are described for contiguously seating passengers in a travel conveyance. In one aspect, a method includes receiving a seat request for multiple seats, and, in response to receiving the seat request, calculating factors associated with each seat in a set of eligible seats. The method includes defining an initial set of seats as a subset of the set of eligible seats, defining a set of factors for each seat in the initial set of seats, associating a priority with the multiple factor sets, where the factors include multiple contiguity and vacancy factors, the contiguity factors being of a higher priority than the vacancy factors. The method includes processing the factors based on the priority to identify an anchor seat from the initial set of seats, assigning the multiple seats based on the anchor seat.

### TECHNICAL FIELD

This specification generally describes systems and processes for assigning one or more travel accommodations to one or more travelers.

### BACKGROUND

Certain online reservation systems are used to make travel reservations. For example, online reservation systems can receive a destination and date for travel from a user. The received destination and date of travel can be used as criteria to perform a search to determine whether a travel accommodation (e.g., a seat) on a travel conveyance (e.g., an aircraft) is available. The search may locate one or more travel accommodations that correspond to the received date and destination details.

### SUMMARY

In general, innovative aspects of the subject matter described in this specification may be embodied in methods that include actions of receiving a seat request, the seat request requesting a plurality of seats, each seat comprising a seat on a travel conveyance, in response to receiving the seat request, calculating factors associated with each seat in a set of eligible seats, defining an initial set of seats as a subset of the set of eligible seats, a set of factors being associated with each seat in the initial set of seats to provide a plurality of factor sets, a priority being associated with the plurality of factor sets, the factors comprising a plurality of contiguity factors and a plurality of vacancy factors, contiguity factors being of a higher priority than vacancy factors, processing factors of the plurality of factor sets based on the priority to identify an anchor seat from the initial set of seats, and assigning the plurality of seats of the seat request based on the anchor seat.

Other implementations of these aspects include corresponding systems, apparatus, and computer programs, configured to perform the actions of the methods, encoded on computer storage devices.

These and other implementations may each optionally include one or more of the following features. For instance, calculating factors may include calculating a unit group factor for each of the eligible seats in the set of eligible seats to provide a set of unit group factors. The anchor seat may be identified based on the set of unit group factors. The plurality of contiguity factors may be included in a hierarchy and the anchor seat may be identified based on the plurality of contiguity factors. A contiguity factor of the plurality of contiguity factors may be associated with a number of contiguous sets in a seat set. A contiguity factor of the plurality of contiguity factors may be associated with a number of contiguous units in a row of seats. The contiguity factor may be further associated with a number of contiguous seats in adjacent rows of seats. The plurality of vacancy factors may be included in a hierarchy and the anchor seat may be identified based on the plurality of vacancy factors. A vacancy factor of the plurality of vacancy factors may be associated with a number of vacant seats in a seat set. A vacancy factor of the plurality of vacancy factors may be associated with a number of vacant seats in a row of seats. The vacancy factor may be further associated with a number of vacant seats in adjacent rows of seats. Processing the factors may include processing factor sets in an order defined by the priority of the factor sets. Processing factors of the plurality of factor sets based on the priority to identify an anchor seat from the initial set of seats may include processing the plurality of contiguity factors in a hierarchical order, and processing the plurality of vacancy factors in a hierarchical order. Calculating one or more factors may include calculating a priority factor for each of the seat in the set of eligible seats to provide a plurality of priority factors. The anchor seat may be identified based on the plurality of priority factors. Processing factors of the plurality of factor sets to identify the anchor seat may include defining one or more subsequent sets of seats, each of the one or more subsequent sets of seats being a subset of the initial set of seats, and identifying the anchor seat from one of the one or more subsequent sets of seats. The travel conveyance may be one of an airplane, a train, a bus and a ship.

Particular implementations of the subject matter described in this specification may be provided so as to realize one or more of the following advantages. A group of individuals traveling together can be provided contiguous accommodations. The contiguous accommodations can be based on factors associated with one or more of the individuals in the group and on factors associated with the actual accommodation to be provided to each of the individuals. For example, passengers on a travel conveyance can be included in a single passenger record. The passengers in the passenger record can be assigned contiguous seats based on the configuration of the travel conveyance, on one or more factors associated with the passengers, and on one or more factors associated with the available seats on the travel conveyance. The passengers can be seated in an optimal contiguous manner providing the passengers with the desired closeness of the contiguous seating, placing the passengers in the best seats available to them, while maintaining optimal seat placement and vacancy factors within the travel conveyance.

The details of one or more implementations of the subject matter described in this specification are set forth in the accompanying drawings, and the description, below. Other features, aspects and advantages of the subject matter will be apparent from the description and drawings, and from the claims.

### BRIEF DESCRIPTION OF DRAWINGS

FIG. 1 is a block diagram illustrating an example system that can execute implementations of the present disclosure.

FIGS. 2A and B depict an example process for determining seat selections.

FIG. 3 is a flow diagram illustrating an example process for assigning seats to passengers included in a passenger name record.

FIG. 4A is a diagram of an example seating plan for a travel conveyance.

FIG. 4B depicts an example chart showing example factors for seats in an initial set of seats.

FIG. 4C is an example chart of assigned seats for passengers included in passenger name records.

Like reference symbols in the various drawings indicate like elements.

### DETAILED DESCRIPTION

In the following text, a detailed description of examples will be given with reference to the drawings. It should be understood that various modifications to the examples may be made. In particular, elements of one example may be combined and used in other examples to form new examples.

For purposes of illustration, a non-limiting example context is provided herein. The example context is directed to a travel accommodation including a seat on a travel conveyance. In some examples, a travel conveyance can include an airplane, a train, a bus and a ship (e.g., a cruise ship). Within the example context of a seat on a travel conveyance, a travel accommodation group includes a group of seats on the travel conveyance that a passenger is eligible for. An actual seat that is assigned to the passenger can be selected from one of the travel accommodation groups. In addition, the actual seat that is assigned to the passenger and each of one or more companions of the passenger can be selected from the same travel accommodation group as that of the passenger's seat.

Although implementations of the present disclosure are discussed in the example context of seats on a travel conveyance, it is appreciated that the present disclosure is applicable in other contexts. In some examples, a travel accommodation can include a room on a travel conveyance (e.g., a room on a cruise ship). In some examples, a non-travel accommodation can be considered and can include an entertainment accommodation such as a seat in an auditorium, stadium, theater or similar facilities. In some examples, an accommodation can include a room such as a hotel room or a suite within an entertainment facility.

In accordance with implementations of the present disclosure, and as discussed in further detail below, booking data and profile data for a traveler, and operational data for the travel conveyance are received. The booking data, the profile data, and the operational data are processed based on a plurality of criteria to identify one or more seat groups that the traveler is eligible for. In some implementations, discussed in further detail below, the traveler is not eligible for any seat group on the travel conveyance (e.g., seating assignments are not currently available). In some implementations, the traveler is eligible for one or more seat groups, and each seat group is associated with one or more seats of the travel conveyance. An index of eligible seat groups is generated. In some examples, seat groups can be identified by respective numbers (e.g., 0-99), and the index of eligible seat groups provides a list of seat groups (e.g., seat groups 40, 52, 60 and 80). The index of eligible seat groups can be provided as input to a seat assignment engine for selecting and assigning a seat for the traveler or selecting and assigning seats for the traveler and one or more companions of the traveler. In some implementations, the booking data can be associated with multiple travelers (e.g., in a passenger name record (PNR)), and the seat assignment engine can assign seats to the travelers. In addition to providing the index of eligible seat groups to the seat assignment engine, a number of requested seats (e.g., the number of travelers included in the booking) can be input to the seat assignment engine.

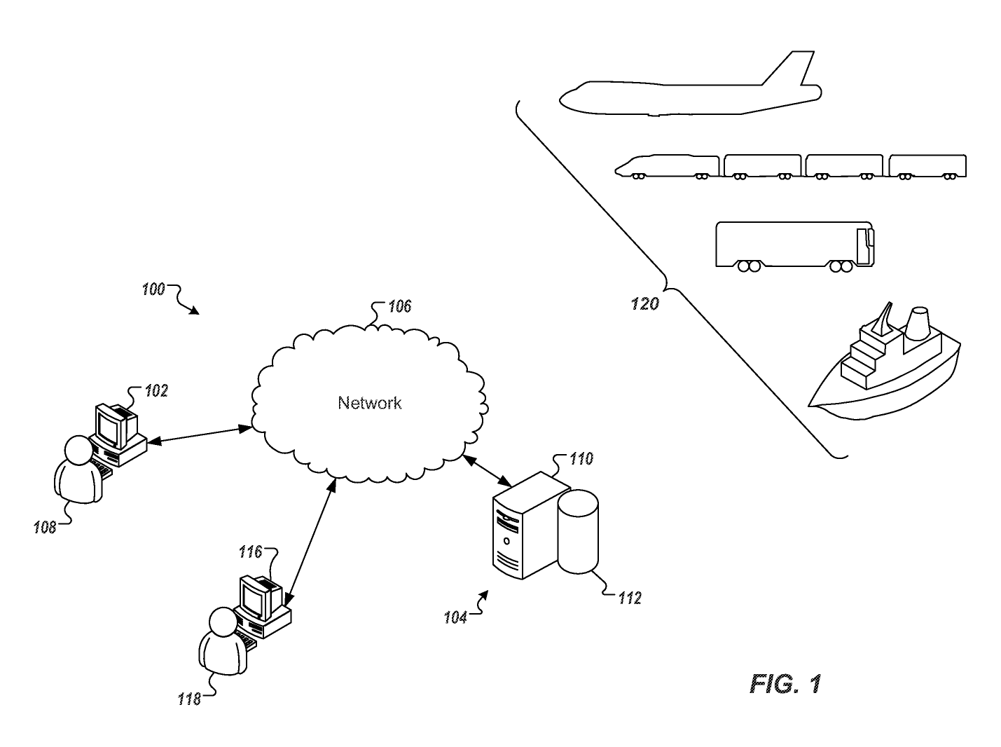

FIG. 1 depicts an example system 100 that can execute implementations of the present disclosure. The example system 100 includes a computing device 102, a computing system 104 and a network 106. The computing device 102 and the computing system 104 can communicate over the network 106. The computing device 102 can be operated by a user 108. The computing system 104 can include one or more computing devices 110 and one or more computer-readable storage devices 112. Another computing device 116 can be provided and can be operated by a user 118.

In some implementations, the computing devices 102, 116 can be computing devices such as laptop or desktop computers, smartphones, personal digital assistants, portable media players, tablet computers, or other appropriate computing devices that can be used to communicate with an electronic social network. In some implementations, the computing device 102, 116 perform client-side operations, as discussed in further detail herein. In some implementations, the computing system 104 can include one or more computing devices such as a computer server. In some implementations, the computing system 104 can represent more than one computing device working together to perform the server-side operations, as discussed in further detail herein. In some implementations, the network 106 can be a public communication network (e.g., the Internet, cellular data network, dialup modems over a telephone network) or a private communications network (e.g., private LAN, leased lines).

In some implementations, the example system 100 can be used to book travel and request assignment of a travel accommodation on a travel conveyance 120. In some examples, the computing system 104 hosts a travel accommodation assignment system (e.g., a seat assignment engine) that can be used to assign one or more travel accommodations on the travel conveyance 120. For example, the user 108 can be a passenger and can access a travel accommodation assignment interface provided on the computing device 102. In some implementations, the travel accommodation assignment system can be provided as part of a web-based system that provides a travel accommodation assignment interface within a general purpose browser executed on the computing device 102. The user 108 can access information regarding the dates of travel and travel accommodations available on the travel conveyance and can generate a booking and request travel accommodation assignment using the web-based system. In some examples, the user 118 can be an agent and can access a travel accommodation assignment interface provided on the computing device 116. In some implementations, the travel accommodation assignment system can be part of a web-based system that provides a travel accommodation assignment interface within a general purpose browser or a specific browser executed on the computing device 116. The user 118 can access information regarding a potential passenger, the dates of travel and travel accommodations available on the travel conveyance and can generate a booking and/or assign travel accommodations using the web-based system. In some examples, the agent can be an independent agent (e.g., a travel agent). In some examples, the agent can be an employee of a travel service provider (e.g., an airline).

The travel associated with a booking can include a journey that can be made up of one or more segments. In some examples, the journey can include a single segment (e.g., a flight departing from a first airport and arriving at a second airport). In some examples, the journey can include multiple segments (e.g., a first flight departing from a first airport and arriving at a second airport, and a second flight departing the second airport and arriving at a third airport).

Each booking can be associated with a passenger name record (PNR) that can include one or more passengers. In some examples, the booking includes a single passenger. In some examples, the booking includes multiple passengers. In accordance with implementations of the present disclosure, seat group eligibility is determined on a per passenger, per segment basis. In some implementations, the presence of multiple passengers on a single booking can influence the seat group eligibility of a particular passenger. In some implementations, the presence of multiple segments in a single journey can influence the seat group eligibility of a particular passenger. In some implementations, the multiple passengers included in a PNR may be assigned seats within proximity to one another, further influencing the seat group eligibility of a particular passenger.

Booking data and profile data for a passenger, and operational data for a travel conveyance of a particular segment are processed to determine one or more seat groups that a passenger is eligible for. The booking data, the profile data and the operational data can be processed using a rules engine. The rules engine processes the data to determine seat group eligibility, seat availability and provides an available seat index that includes a list of qualified (e.g., based on eligible seat groups) and available (i.e., open or un-assigned) seats per passenger, per segment.

In accordance with implementations of the present disclosure, the available seat index is provided as input to a seat assignment algorithm that can assign a particular seat to a passenger for each segment of travel. In cases where the PNR includes multiple passengers, the seat assignment algorithm may further base the seat assignments for each passenger on one or more contiguity factors, vacancy factors, and priority factors. Implementations of the seat assignment algorithm will be discussed in further detail below.

In some examples, the booking data can include information that is specific to the booked journey, the one or more segments that make up the journey, and the number of passengers involved in the journey. The booking data can be processed on a per segment, per passenger basis, although the booking data of one segment can influence the seat group eligibility of the particular passenger on another segment within the same journey, and the profile data of one passenger can influence the seat group eligibility of another passenger within the same PNR. In some examples, the profile data can include information that is specific to a particular passenger of the booked journey. The profile data can be processed on a per segment basis. In addition, the profile data can be processed for each traveler included in a PNR for a multiple passenger booking. In doing so, the seat assignment of each PNR-associated passenger can be influenced by the seat group eligibility of the other passengers included in the PNR. In some examples, the same seat group eligibility can be provided for each passenger in the PNR. In some examples, the operational data can include information that is specific to a particular travel conveyance of a particular segment, and the seats already assigned for the particular segment. The operational data can be processed on a per segment basis.

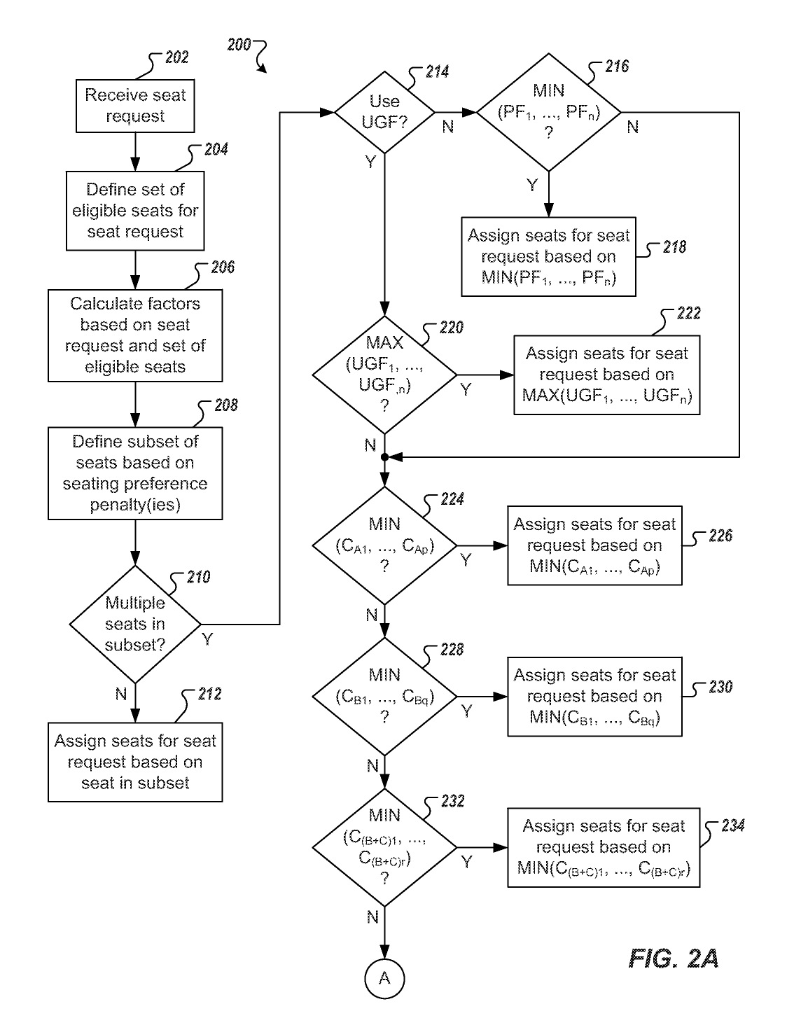

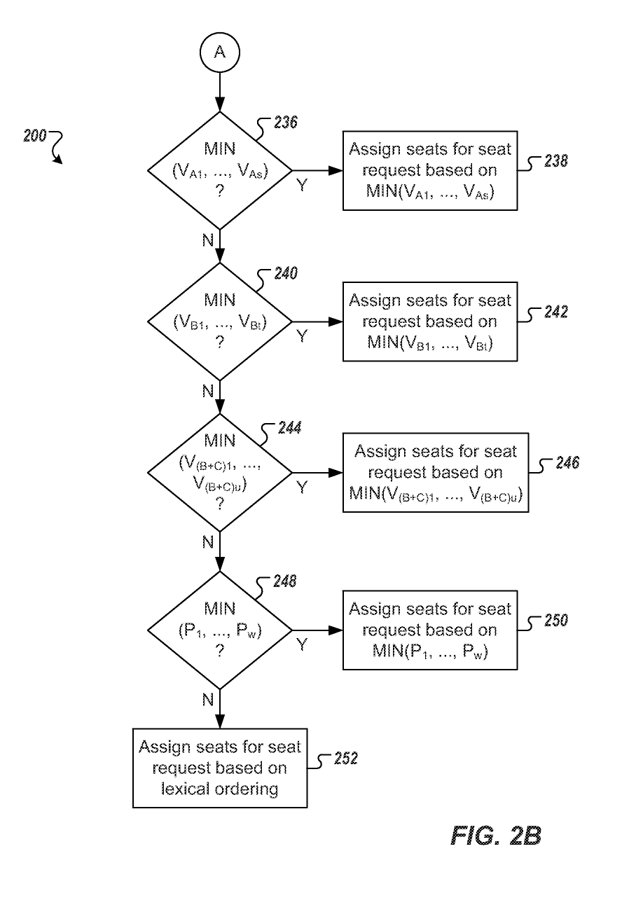

FIGS. 2A and 2B depict an example process 200 for determining seat selections. In some examples, the process 200 can be implemented using one or more computer program applications executed using one or more computing devices. For purposes of illustration, a non-limiting example context is provided that is directed to a travel accommodation including a unit as a seat on a travel conveyance where contiguous units can form a seat set and a row.

A seat request is received (202). The seat request can be for a PNR that includes multiple passengers, requesting seats for each passenger identified in the PNR. A set of eligible seats for the seat request is defined (204). In some examples, the set of eligible seats is provided as an available seat index and includes a sub-set of all seats provided in the travel conveyance. In some examples, one or more eligible seat groups for the passengers of the subject PNR are identified, and the set of eligible seats includes seats provided in the one or more eligible seat groups. The preliminary set of eligible seats can be further refined by one or more of the following: removing already assigned seats, removing seats associated with a particular special service request (SSR), if none of the passengers in the PNR have the SSR, and removing seats that are identified as unavailable based on one or more characteristics of the passengers (e.g., seats located in a smoking area of the travel conveyance will be eliminated if any of the PNR-associated passengers indicated a non-smoking preference).

Factors based on the seat request and the set of eligible seats are calculated (206). In some examples, the factors can include a unit group factor (UGF), which can also be referred to as a seat group factor, a priority factor (PF), contiguity factors and vacancy factors. A UGF, a PF, one or more contiguity factors and one or more vacancy factors can be associated with each seat included in the set of eligible seats. Further, each seat included in the set of eligible seats can have a pre-determined priority (P) associated therewith. In some examples, the contiguity and vacancy factors can be based on criteria that include the number of passengers included in the PNR, the travel conveyance equipment type and configuration, the number of eligible seats included in the set of eligible seats, the location within the travel conveyance of the eligible seats, and any seat-dependent SSRs for a particular passenger included in the PNR. As discussed in further detail herein, the factors can be processed to identify an anchor seat for the particular PNR. As used herein, the anchor seat includes an initial seat assignment for a passenger within a PNR, on which subsequent seat assignments for other passengers in the PNR are based.

A first contiguity value (Contiguity_A) can represent the maximum number of contiguous seats in at a seat set level. The number of seats in a seat set can be defined based on the travel conveyance configuration. For example, the seat set can be the number of adjacent contiguous seats in a row (e.g., seats adjacent to one another in a row that are not separated (e.g., by an aisle, a gap, a structure). Accordingly, a row can include multiple seat sets. In some examples, a first contiguity factor (C_{A}) for each seat in the set of eligible seats can be determined based on Contiguity_A and the number of passengers (PAX) in the PNR, for which seat assignments have been requested. In this manner, C_{A} is specific to the PNR and can be determined based on the following relationship:

$${C}_{A} = \{ \begin{matrix}PAX , & Contiguity\_A < PAX \\ Contiguity\_A - PAX , & Contiguity\_A \geq PAX\end{matrix}$$

More plainly stated, C_{A} is set equal to PAX, if Contiguity_A is less than PAX, and is equal to the difference between Contiguity_A and PAX, if Contiguity_A is greater than or equal to PAX.

A second contiguity value (Contiguity_B) can represent the maximum number of contiguous seats in a row. The number of seats in a row can be defined based on the travel conveyance configuration. For example, the number of seats in a row can be the number of contiguous seats in a row, where the seats may be separated (e.g., by an aisle, a gap, a structure). In some examples, a second contiguity factor (C_{B}) for each seat in the set of eligible seats can be determined based on Contiguity_B and PAX. In this manner, C_{B} is specific to the PNR and can be determined based on the following relationship:

$${C}_{B} = \{ \begin{matrix}PAX , & Contiguity\_B < PAX \\ Contiguity\_B - PAX , & Contiguity\_B \geq PAX\end{matrix}$$

More plainly stated, C_{B} is set equal to PAX, if Contiguity_B is less than PAX, and is equal to the difference between Contiguity_B and PAX, if Contiguity_B is greater than or equal to PAX.

A third contiguity value (Contiguity_C) can represent the number of contiguous seats located in adjacent rows. For example, the Contiguity_C can be provided as the maximum number of contiguous seats in an adjacent row with respect to a particular seat being considered. In some examples, a third contiguity factor (C_{B+C}) for each seat in the set of eligible seats can be determined based on Contiguity_B, Contiguity_C and PAX. In this manner, C_{B+C} is specific to the PNR and can be determined based on the following relationship:

$${C}_{B + C} = \{ \begin{matrix}PAX , & ( Contiguity\_B + Contiguity\_C ) < PAX \\ Contiguity\_B + Contiguity\_C - PAX , & ( Contiguity\_B + Contiguity\_C ) \geq PAX\end{matrix}$$

More plainly stated, C_{B+C} is set equal to PAX, if the sum of Contiguity_B and Contiguity_C is less than PAX, and is equal to the difference between the sum of Contiguity_B and Contiguity_C and PAX, if the sum of Contiguity_B and Contiguity_C is greater than or equal to PAX.

A first vacancy value (Vacancy_A) can represent a total number of vacant seats within a seat set. As discussed above, the number of seats in a seat set can be defined based on the travel conveyance configuration. For example, the seat set can be the number of adjacent contiguous seats in a row (e.g., seats adjacent to one another in a row that are not separated (e.g., by an aisle, a gap, a structure). Accordingly, a row can include multiple seat sets. In some examples, a first vacancy factor (V_{A}) for each seat in the set of eligible seats can be determined based on Vacancy_A and PAX. In this manner, V_{A} is specific to the PNR and can be determined based on the following relationship:

$${V}_{A} = \{ \begin{matrix}PAX , & Vacancy\_A < PAX \\ Vacancy\_A - PAX , & Vacancy\_A \geq PAX\end{matrix}$$

More plainly stated, V_{A} is set equal to PAX, if Vacancy_A is less than PAX, and is equal to the difference between Vacancy_A and PAX, if Vacancy_A is greater than or equal to PAX.

A second vacancy value (Vacancy_B) can represent the maximum number of vacant seats in a row. As discussed above, the number of seats in a row can be defined based on the travel conveyance configuration. For example, the number of seats in a row can be the number of contiguous seats in a row, where the seats may be separated (e.g., by an aisle, a gap, a structure). In some examples, a second vacancy factor (V_{B}) for each seat in the set of eligible seats can be determined based on Vacancy_B and PAX. In this manner, V_{B} is specific to the PNR and can be determined based on the following relationship:

$${V}_{B} = \{ \begin{matrix}PAX , & Vacancy\_B < PAX \\ Vacancy\_B - PAX , & Vacancy\_B \geq PAX\end{matrix}$$

More plainly stated, V_{B} is set equal to PAX, if Vacancy_B is less than PAX, and is equal to the difference between Vacancy_B and PAX, if Vacancy_B is greater than or equal to PAX.

A third vacancy value (Vacancy_C) can represent the number of vacant seats located in adjacent rows. For example, the Vacancy_C can be provided as the maximum number of vacant seats in an adjacent row with respect to a particular seat being considered. In some examples, a third vacancy factor (V_{B+C}) for each seat in the set of eligible seats can be determined based on Vacancy_B, Vacancy_C and PAX. In this manner, V_{B+C} is specific to the PNR and can be determined based on the following relationship:

$${V}_{B + C} = \{ \begin{matrix}PAX , & ( Vacancy\_B + Vacancy\_C ) < PAX \\ Vacancy\_B + Vacancy\_C - PAX , & ( Vacancy\_B + Vacancy\_C ) \geq PAX\end{matrix}$$

More plainly stated, V_{B+C} is set equal to PAX, if the sum of Vacancy_B and Vacancy_C is less than PAX, and is equal to the difference between the sum of Vacancy_B and Vacancy_C and PAX, if the sum of Vacancy_B and Vacancy_C is greater than or equal to PAX.

A fourth vacancy value (Vacancy_C′) can represent the number of vacant seats located in a row and an adjacent back row (e.g., the last row of seats in the travel conveyance). In some examples, Vacany_C′ is determined as the sum of Vacancy_B and the number of vacant seats in the back row.

An initial subset of seats of the set of eligible seats is defined based on one or more seating preference penalties (208). Seating preferences are determined for each of the PNR-associated passengers. In some implementations, seats included in the initial set of eligible seats may be penalized if they do not satisfy a seating preference. In some implementations, seats included in the set of eligible seats may be penalized if they satisfy additional preferences defined by the travel service provider, but are not explicitly requested by the particular passenger. In some examples, penalized seats are not included in the initial subset of seats.

In some implementations, in cases where a PNR-associated passenger performed the booking, the subset of seats does not include seats that do not satisfy the particular passenger's seating preference. For example, the particular passenger can indicate a preference for a window seat. In this example, non-window seats are penalized in the set of eligible seats for the PNR and might not be included in the subset of seats. In some examples, a travel service provider may define a preference to seat passengers with infants in certain seats. If the particular passenger does not indicate that they are traveling with an infant, the travel service provider may penalize seats that are included in the set of eligible seats that meet this criterion. Such seats might not be included in the initial subset of seats.

In some implementations, in cases where the booking was performed by an agent, the agent can identify a particular passenger included in the PNR and the subset of seats can include seats that satisfy the particular passenger's seating preference. For example, an SSR associated with the particular passenger in the PNR can indicate the passenger requests seating in seats designated as having extra leg room. In this example, the subset of eligible seats that satisfy the SSR for the particular passenger includes seats with extra leg room. In this example, seats without extra leg room included in the set of eligible seats can be penalized and might not be included in the initial subset of seats.

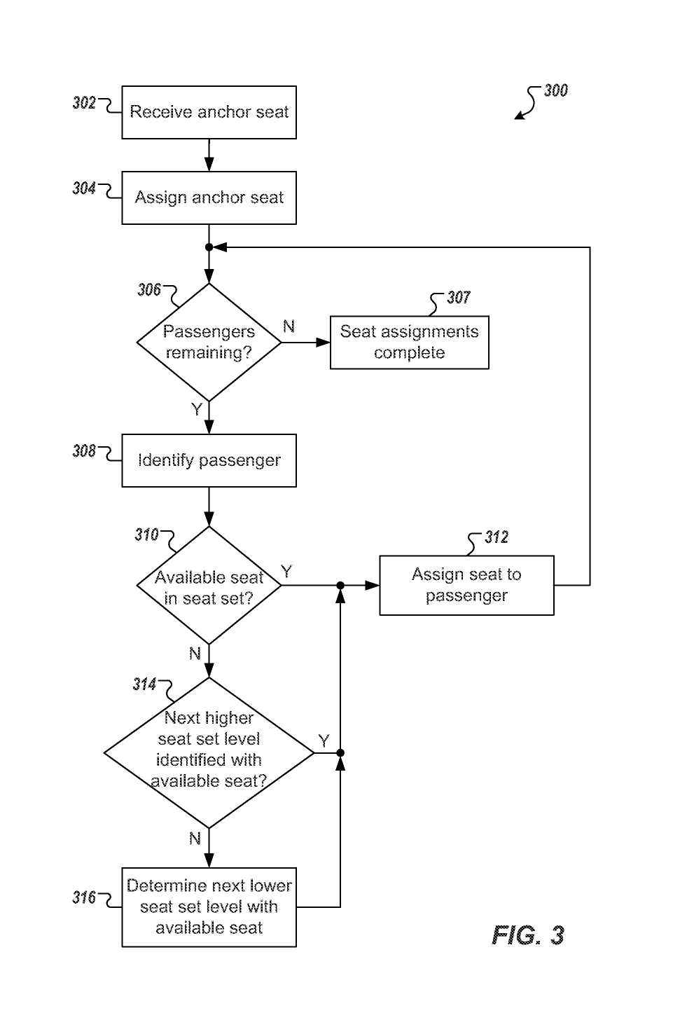

Continuing with the process 200, it is determined whether the initial subset of seats includes multiple seats (210). If the initial subset of seats does not include multiple seats (i.e., the initial subset of seats includes a single seat), the single seat is selected as the anchor seat, and the seats for the seat request are assigned based on the anchor seat (212). Assignment of the seats is discussed in further detail herein with respect to FIG. 3.

If it is determined that the initial subset of seats includes multiple seats (e.g., n seats, where n is an integer that is greater than 1), it is determined whether a UGF associated with each of the seats in the initial subset of eligible seats should be used to identify the anchor seat (214). In some implementations, a booking system can include a UGF indicator that, if set, indicates that the UGF should be used by a seat assignment algorithm to assign the anchor seat. If the UGF indicator is not set, the seat assignment algorithm can proceed to use a priority factor (PF) to assign the anchor seat.

In some implementations, one or more rules can be used to determine whether the UGF or the PF is used in determining the anchor seat. In some examples, a rule can be based on an amount of time prior to a scheduled flight departure time. For example, a rule can specify that the UGF is used, if the seat assignment request is received more than a threshold number of hours (e.g., six hours) prior to the scheduled flight departure time. Consequently, and using the example rule, if the seat assignment request is received less than the threshold number of hours prior to the scheduled flight departure time, the rule can specify that the PF is used to identify the anchor seat.

In some examples, the UGF can be provided as a numerical value. Each seat in the subset of seats can include an associated UGF. Each UGF can be determined based on contiguity and vacancy values associated with the particular seat. A UGF can be determined for each seat included in the subset of eligible seats based on the following example relationship:

UGF=UG+(HUG×Q×(−1))−Q

where UG is a unit group associated with the particular seat, HUG is the highest-numbered unit group provided in the travel conveyance and Q is a variable. A unit group (which may also be referred to as a seat group) refers to the logical grouping of seats in a travel conveyance based on the configuration of the seats in the travel conveyance. The unit group can be identified by the carrier based on a prescribed value or worth (e.g., by proximity, seating comfort, or available amenities to a customer when seated in a seat included in the unit group).

In some implementations, Q can be provided as a numerical value based on PAX, the contiguity values and the vacancy values. In some examples, Q can be provided based on the following relationship:

$$Q = \{ \begin{matrix}0 , & PAX \leq Contiguity\_A and PAX \leq Vacancy\_A \\ 1 , & PAX \leq Contiguity\_B and PAX \leq Vacancy\_B \\ 2 , & PAX \leq Contiguity\_A or PAX \leq Vacancy\_A \\ 3 , & PAX \leq Contiguity\_B or PAX \leq Vacancy\_B \\ 4 , & PAX \leq {Vacancy\_C}^{′} \\ 5 , & in all other cases\end{matrix}$$

In some examples, the PF can be a numerical value. Each seat in the subset of seats can include an associated PF. In some implementations, each PF can be determined based on a priority zone number associated with the particular seat. In some implementations, each PF can be determined based on a sorting of priority zone numbers according to occupancy (e.g., by computing a ratio between the occupied seats and the total available seats). In some examples, a priority zone option can indicate how PF is to be determined. For example, setting the priority zone option to “number” can indicate PF is to be computed based on a priority zone number. Setting the priority zone option to “occupancy” can indicate PF is to be computed based on an occupancy value.

By way of non-limiting example, a travel conveyance can include four priority zones (e.g., 1-4). An effective priority value (EPV) can be computed for each seat in the set of eligible seats. The effective priority value for a seat can be used to calculate the PF for the seat. If the priority zone option is set to “number”, the effective priority value for a seat is based on its location in one of the four priority zones on the travel conveyance. For example:

EPV=1 for seats located in priority zone 1

EPV=2 for seats located in priority zone 2

EPV=3 for seats located in priority zone 3

EPV=4 for seats located in priority zone 4

If the priority zone option is set to “occupancy”, the EPV for a seat is based on an occupancy factor percentage, where the occupancy factor percentage=(the number of occupied seats in a priority zone÷the total number of seats in the priority zone)×100. For example:

Priority zone 1 occupancy factor percentage=25%

Priority zone 2 occupancy factor percentage=65%

Priority zone 3 occupancy factor percentage=5%

Priority zone 4 occupancy factor percentage=80%

EPV=2 for seats located in priority zone 1

EPV=3 for seats located in priority zone 2

EPV=1 for seats located in priority zone 3 (least occupied)

EPV=4 for seats located in priority zone 4 (most occupied)

The effective priority value of a seat can be used to calculate the PF for the seat. The PF for a particular seat can be determined based on the following example relationship:

PF=EPV+((HPZ+1)×Q)

where HPZ indicates the highest-numbered priority zone, and Q is provided as discussed above. In the example of four priority zones, the highest-numbered priority zone can include zone 4.

Continuing with the example process or FIG. 2, if it is determined that the UGFs are not to be used to select the anchor seat, it is determined whether a minimum PF is provided for the seats in the initial subset of seats (216). For example, each seat in the initial subset of seats can include a PF associated therewith to provide a set of PFs (e.g., PF₁, . . . , PFₙ). If there is a single minimum PF in the set of PFs, the seat associated with the minimum PF can be selected as the anchor seat, which is used to assign seats for the seat request (218). If there is not a single minimum PF in the set of PFs, the process 200 can continue without identifying the anchor seat based on PF.

If it is determined that the UGFs are to be used to select the anchor seat, it is determined whether a single maximum UGF is provided for the seats in the initial subset of seats (220). For example, each seat in the initial subset of seats can include a UGF associated therewith to provide a set of UGFs (e.g., UGF₁, . . . , UGFₙ). If there is a single maximum UGF in the set of UGFs, the seat associated with the maximum UGF can be selected as the anchor seat, which is used to assign seats for the seat request (222). If there is not a single maximum UGF in the set of UGFs, the process 200 can continue without identifying the anchor seat based on UGF.

In some examples, a second subset of seats (e.g., including p seats, where p is less than or equal to n) can be determined based on UGF₁, . . . , UGFₙ for continued processing. For example, if a plurality of UGFs in the set of UGFs are each equal to a maximum of all of UGF₁, . . . , UGFₙ (i.e., there are multiple maximum UGFs in the set UGF₁, . . . , UGFₙ), the seats associated with the plurality of UGFs can define the second subset of seats. By way of non-limiting example, an example set of UGFs can include the values −6, −6, −2, 1, 1, 4, 4, 4. Consequently, the value 4 is the maximum value provided in the example set of UGFs, and three seats are associated with the value 4 (i.e., the value 4 is provided three times in the example set of UGFs). Consequently, a second subset of seats can be defined and can include the seats associated with the UGFs that are equal to 4 (i.e., p=3). In some examples, if all of the UGFs in the set of UGFs are equal, the second subset of seats is the same as the initial subset of seats (i.e., p=n).

Continuing with the example process 200, it is determined whether a single minimum C_{A} is provided for the seats in the second subset of seats (224). For example, each seat in the second subset of seats can include a C_{A} associated therewith to provide a set of C_{A}s (e.g., C_{A1}, . . . , C_{Ap}). If there is a single minimum C_{A} in the set of C_{A}s, the seat associated with the minimum C_{A} can be selected as the anchor seat, which is used to assign seats for the seat request (226). If there is not a single minimum C_{A} in the set of C_{A}s, the process 200 can continue without identifying the anchor seat based on C_{A}.

In some examples, a third subset of seats (e.g., including q seats, where q is less than or equal to p) can be determined based on C_{A1}, . . . , C_{Ap} for continued processing. For example, if a plurality of C_{A}s in the set of C_{A}s are each equal to a minimum of all of C_{A1}, . . . , C_{Ap} (i.e., there are multiple minimum C_{A}s in the set C_{A1}, . . . , C_{Ap}), the seats associated with the plurality of C_{A}s can define the third subset of seats. By way of non-limiting example, an example set of C_{A}s can include the values 1, 1, 1, 2, 2, 3, 3, 3. Consequently, the value 1 is the minimum value provided in the example set of C_{A}s, and three seats are associated with the value 1 (i.e., the value 1 is provided three times in the example set of C_{A}s). Consequently, a third subset of seats can be defined and can include the seats associated with the C_{A}s that are equal to 1 (i.e., q=3). In some examples, if all of the C_{A}s in the set of C_{A}s are equal, the third subset of seats is the same as the second subset of seats (i.e., q=p).

Continuing with the example process 200, it is determined whether a single minimum C_{B} is provided for the seats in the third subset of seats (228). For example, each seat in the third subset of seats can include a C_{B} associated therewith to provide a set of C_{B}s (e.g., C_{B1}, . . . , O_{Bq}). If there is a single minimum C_{B} in the set of C_{B}s, the seat associated with the minimum C_{B} can be selected as the anchor seat, which is used to assign seats for the seat request (230). If there is not a single minimum C_{B} in the set of C_{B}s, the process 200 can continue without identifying the anchor seat based on C_{B}.

In some examples, a fourth subset of seats (e.g., including r seats, where r is less than or equal to q) can be determined based on C_{B1}, . . . , C_{Bq} for continued processing. For example, if a plurality of C_{B}s in the set of C_{B}s are each equal to a minimum of all of C_{B1}, . . . , C_{Bq} (i.e., there are multiple minimum C_{B}s in the set C_{B1}, . . . , C_{Bq}), the seats associated with the plurality of C_{B}s can define the fourth subset of seats. By way of non-limiting example, an example set of C_{B}s can include the values 2, 2, 2, 3, 4, 4. Consequently, the value 2 is the minimum value provided in the example set of C_{B}s, and three seats are associated with the value 2 (i.e., the value 2 is provided three times in the example set of C_{B}s). Consequently, a fourth subset of seats can be defined and can include the seats associated with the C_{B}s that are equal to 2 (i.e., r=3). In some examples, if all of the C_{B}s in the set of C_{B}s are equal, the fourth subset of seats is the same as the third subset of seats (i.e., r=q).

Continuing with the example process 200, it is determined whether a single minimum C_{(B+C)} is provided for the seats in the fourth subset of seats (232). For example, each seat in the fourth subset of seats can include a C_{(B+C)} associated therewith to provide a set of C_{(B+C)}s (e.g., C_{(B+C)1}, . . . , C_{(B+C)r}). If there is a single minimum C_{(B+C)} in the set of C_{(B+C)}s, the seat associated with the minimum C_{(B+C)} can be selected as the anchor seat, which is used to assign seats for the seat request (234). If there is not a single minimum C_{(B+C)} in the set of C_{(B+C)}s, the process 200 can continue without identifying the anchor seat based on C_{(B+C)}.

In some examples, a fifth subset of seats (e.g., including s seats, where s is less than or equal to r) can be determined based on C_{(B+C)1}, . . . , C_{(B+C)r} for continued processing. For example, if a plurality of C_{(B+C)}s in the set of C_{(B+C)}s are each equal to a minimum of all of C_{(B+C)1}, . . . , C_{(B+C)}r (i.e., there are multiple minimum C_{(B+C)}s in the set C_{(B+C)1}, . . . , C_{(B+C)}r), the seats associated with the plurality of C_{(B+C)}s can define the fifth subset of seats. By way of non-limiting example, an example set of C_{(B+C)}s can include the values 8, 8, 8, 8, 8, 8. Consequently, the value 8 is the minimum value provided in the example set of C_{(B+C)}s, and six seats (all seats in the set) are associated with the value 8. Consequently, a fifth subset of seats can be defined and can include the seats associated with the C_{(B+C)}s that are equal to 8 (i.e., s=6). In this example, all of the C_{(B+C)}s in the set of C_{(B+C)}s are equal, such that the fifth subset of seats is the same as the fourth subset of seats (i.e., s=r).

Continuing with the example process 200, it is determined whether a single minimum V_{A} is provided for the seats in the fifth subset of seats (236). For example, each seat in the third subset of seats can include a V_{A} associated therewith to provide a set of V_{A} s (e.g., V_{A 1}, . . . , V_{As}). If there is a single minimum V_{A} in the set of V_{A} s, the seat associated with the minimum V_{A} can be selected as the anchor seat, which is used to assign seats for the seat request (238). If there is not a single minimum V_{A} in the set of V_{A}s, the process 200 can continue without identifying the anchor seat based on V_{A}.

In some examples, a sixth subset of seats (e.g., including t seats, where t is less than or equal to s) can be determined based on V_{A1}, . . . , V_{As} for continued processing. For example, if a plurality of V_{A}s in the set of V_{A}s are each equal to a minimum of all of V_{A1}, . . . , V_{As} (i.e., there are multiple minimum V_{A}s in the set V_{A1}, . . . , V_{As}), the seats associated with the plurality of V_{A}s can define the sixth subset of seats. By way of non-limiting example, an example set of V_{A}s can include the values 3, 3, 3, 4, 4, 4. Consequently, the value 3 is the minimum value provided in the example set of V_{A}s, and three seats are associated with the value 3. Consequently, a sixth subset of seats can be defined and can include the seats associated with the V_{A}s that are equal to 3 (i.e., t=3). In some examples, if all of the V_{A}s in the set of V_{A}s are equal, the sixth subset of seats is the same as the fifth subset of seats (i.e., t=s).

Continuing with the example process 200, it is determined whether a single minimum V_{B} is provided for the seats in the sixth subset of seats (240). For example, each seat in the sixth subset of seats can include a V_{B} associated therewith to provide a set of V_{B}s (e.g., V_{B1}, . . . , V_{Bt}). If there is a single minimum V_{B} in the set of V_{B}s, the seat associated with the minimum V_{B} can be selected as the anchor seat, which is used to assign seats for the seat request (242). If there is not a single minimum V_{B} in the set of V_{B}s, the process 200 can continue without identifying the anchor seat based on V_{B}.

In some examples, a seventh subset of seats (e.g., including u seats, where u is less than or equal to t) can be determined based on V_{A1}, . . . , V_{As} for continued processing. For example, if a plurality of V_{A}s in the set of V_{A}s are each equal to a minimum of all of V_{B1}, . . . , V_{Bt} (i.e., there are multiple minimum V_{B}s in the set V_{B1}, . . . , V_{Bt}), the seats associated with the plurality of V_{B}s can define the seventh subset of seats. By way of non-limiting example, an example set of V_{B}s can include the values 3, 3, 3, 6, 6, 6. Consequently, the value 3 is the minimum value provided in the example set of V_{B}s, and three seats are associated with the value 3. Consequently, a seventh subset of seats can be defined and can include the seats associated with the V_{B}s that are equal to 3 (i.e., u=3). In some examples, if all of the V_{B}s in the set of V_{B}s are equal, the seventh subset of seats is the same as the sixth subset of seats (i.e., u=t).

Continuing with the example process 200, it is determined whether a single minimum V_{(B+C)} is provided for the seats in the seventh subset of seats (244). For example, each seat in the seventh subset of seats can include a V_{(B+C)} associated therewith to provide a set of V_{(B+C)}s (e.g., V_{(B+C)1}, . . . , V_{(B+C)u}). If there is a single minimum V_{(B+C)} in the set of V_{(B+C)}s, the seat associated with the minimum V_{(B+C)} can be selected as the anchor seat, which is used to assign seats for the seat request (246). If there is not a single minimum V_{(B+C)} in the set of V_{(B+C)}s, the process 200 can continue without identifying the anchor seat based on V_{(B+C)}.

In some examples, an eighth subset of seats (e.g., including w seats, where w is less than or equal to u) can be determined based on V_{(B+C)1}, . . . , V_{(B+C)u} for continued processing. For example, if a plurality of V_{(B+C)}s in the set of V_{(B+C)}s are each equal to a minimum of all of V_{(B+C)1}, . . . , V_{(B+C)u} (i.e., there are multiple minimum V_{(B+c)}s in the set V_{(B+C)1}, . . . , V_{(B+C)u}), the seats associated with the plurality of V_{(B+C)}s can define the eighth subset of seats. By way of non-limiting example, an example set of V_{(B+C)}s can include the values 12, 12, 16, 16, 18, 18. Consequently, the value 12 is the minimum value provided in the example set of V_{(B+C)}s, and two seats are associated with the value 12. Consequently, an eighth subset of seats can be defined and can include the seats associated with the V_{(B+C)}s that are equal to 12 (i.e., w=3). In some examples, if all of the V_{(B+C)}s in the set of V_{(B+C)}s are equal, the eighth subset of seats is the same as the seventh subset of seats (i.e., w=u).

Continuing with the example process 200, it is determined whether a single minimum P is provided for the seats in the eighth subset of seats (248). For example, each seat in the eighth subset of seats can include a P associated therewith to provide a set of Ps (e.g., P₁, . . . , R_{W}). If there is a single minimum P in the set of Ps, the seat associated with the minimum P can be selected as the anchor seat, which is used to assign seats for the seat request (250). If there is not a single minimum P in the set of Ps, the process 200 can continue without identifying the anchor seat based on P.

In some examples, a ninth subset of seats (e.g., including x seats, where x is less than or equal to w) can be determined based on P₁, . . . , P_{W} for continued processing. For example, if a plurality of Ps in the set of Ps are each equal to a minimum of all of P₁, . . . , P_{W} (i.e., there are multiple minimum Ps in the set P₁, . . . , P_{W}), the seats associated with the plurality of Ps can define the ninth subset of seats. In some examples, if all of the Ps in the set of Ps are equal, the ninth subset of seats is the same as the eighth subset of seats (i.e., x=w).

Continuing with the example process 200, if the anchor seat is not identified based on any of PF or UGF, C_{A}, C_{B}, C_{(B+C)}, V_{A}, V_{B}, V_{(B+C)} or P, the anchor seat can be selected based on a lexical ordering of the seats provided in the ninth subset of seats (252). In some implementations, lexical ordering can be an ordering of seats in a travel conveyance from the front to the rear of the travel conveyance. For example, a seat on an aircraft can be represented by a row number and a column letter. In this example, a seat with a lower row number is in ahead of a seat with a higher number in the lexical ordering (e.g., seat 2A is before seat 5A in the ordering). If two seats have the same row number (e.g., row number 2), the column letter determines the ordering of both seats using alphabetic sorting (e.g., seat 2C is before seat 2F in the lexical ordering).

An anchor seat is selected by the process 200 shown in FIG. 2. In some implementations, each process step can be performed at a particular hierarchical level in order to identify the anchor seat, further defining an anchor seat selection hierarchy. In some implementations, the anchor seat selection hierarchy may include fewer levels than those shown in FIG. 2. In some implementations, the anchor seat selection hierarchy may be performed in a different order than the order shown in FIG. 2. In some implementations, additional levels may be added at any point in the anchor seat selection hierarchy, for example, to further refine the anchor seat selection process.

Once the anchor seat is identified, the seating process continues by contiguously assigning seats to the remaining passengers in the PNR based on the anchor seat. FIG. 3 is a flow diagram illustrating an example process 300 for assigning seats to passengers included in a PNR. In some examples, the process 300 can be implemented using one or more computer program applications executed using one or more computing devices. For purposes of illustration, a non-limiting example context is provided that is directed to a travel accommodation including a unit as a seat on a travel conveyance where contiguous units can form a seat set and a row.

In general, the anchor seat can be located in a seat set, which can be referred to as a pivot seat set. A contiguous seating process begins with the assignment of the anchor seat to a first passenger in a PNR. The seating process continues by assigning contiguous seats to the remaining passengers in the PNR, traversing each from one seat set to the next seat set in ascending order of the seat sets (e.g., increasing numerical order of the seat sets). The seating process continues as long as there are remaining passengers left to be assigned seats. If the seating process reaches the last highest seat set in the travel conveyance and there are still remaining passengers needing seat assignments, the seating process continues by effectively reversing direction. The seating process retains the assignment of the anchor seat to the first passenger in the PNR and proceeds to contiguously assign seats to the remaining passengers in the PNR, traversing each from one seat set to the next seat set in descending order of the seat sets (e.g., decreasing numerical order of the seat sets).

Referring back to FIG. 3, an anchor seat is received (302). The anchor seat is identified at a PNR level and is used as the base or starting seat for the seat assignment process for the passengers in the PNR. The anchor seat can be assigned to a passenger included in a multiple passenger PNR (304). For example, a seat assignment algorithm can select and assign the anchor seat to a particular passenger in the PNR, whose seating preference was used to identify the anchor seat. In some examples, the particular passenger may be the passenger that performed the booking. In some examples, where the booking was performed by an agent, the agent can identify the particular passenger from among the passengers included in the PNR. If it is determined that all of the passengers provided in the PNR have been assigned seats (306), seat assignment is complete (307). If there are remaining passengers in the PNR that require seat assignments (306), a passenger is identified (308). If it is determined that there is an available seat, contiguous to the anchor seat and in the same seat set as the anchor seat (310), the identified available seat is assigned to the identified passenger (312). The process 300 continues to determine whether there are other passengers in the PNR requiring seat assignments (306).

If it is determined that there is not an available seat contiguous to the anchor seat and in the same seat set as the anchor seat (310), the process 300 determines whether a next higher seat set level with respect to the seat set level of the seat set that includes the anchor seat has an available seat (314). If a next higher seat set level with an available seat is identified, the identified available seat is assigned to the identified passenger (312). The process 300 continues to determine whether there are other passengers in the PNR requiring seat assignments (306).

If a next higher seat set level is not determined (e.g., the highest seat set level on the travel conveyance has been reached or the next higher seat set level does not have any available seats), the process 300 determines a next lower seat set level with respect to the seat set level of the seat set that includes the anchor seat that has an available seat (316). The identified available seat is assigned to the identified passenger (312). The process 300 continues to determine whether there are other passengers in the PNR requiring seat assignments (306).

When the seat assignment process traverses from the seat set that includes the anchor seat to another contiguous seat set in order to continue to assign seats to other passengers in the PNR, the seat assignment process can identify the most dense area of the next seat set (the area of the seat set with the largest number of contiguous vacant seats) and identify a seat set level anchor seat where the continued assignment of seats to passengers in the seat set begins. For example, the seat set level anchor seat is assigned to a passenger and remaining passengers are seated on an alternating left-right approach to the seat set level anchor seat until either all the passengers in the PNR have been assigned seats or until there are no more available seats in the seat set. In the latter case, the seat assignment process continues to the next contiguous seat set.

For example, a three-element seat set can include vacant seats 5A, 5B, and occupied 5C. In this example, the seat set level anchor seat can be identified as seat 5A. Seat 5A can be assigned to a passenger and seat 5B can be assigned to another passenger. In another example, a six element seat set can include vacant seats 6A, 6B, 6D, 6E, 6F, and occupied seat 6C. The seat assignment process can identify seat 6D as the seat set level anchor seat and continue to assign seats to passengers using an alternating left-right approach (e.g., a first passenger is assigned to the seat set level anchor seat 6D, a second passenger is assigned to seat 6B (the next available seat to the left of the seat set level anchor seat), a third passenger is assigned to seat 6E (the next available seat to the right of the seat set level anchor seat) and so on) until there are no more available seats in the seat set or until all the passengers in the PNR have been assigned seats.

In some implementations, the seat assignment algorithm identifies an anchor seat for a passenger included in a multiple passenger PNR based on contiguity and vacancy factors. The contiguity and vacancy factors are based, in part, on the configuration of the travel conveyance (e.g., the number of seats in a seat set, the number of seat sets in a row, and the total number of rows included in the travel conveyance) and the PAX (i.e., the number of passengers included in the PNR). The seat assignment algorithm identifies an anchor seat for a passenger in a multiple passenger PNR emphasizing contiguous seating (togetherness) over placement in a particular seat group, while considering an optimal fit. For example, in order to seat the passengers in the PNR as close to one another as possible, the seat assignment algorithm may select an anchor seat in a lower level seat group. This preferred contiguity can be reflected in the UGF and/or the PF for a seat. In addition, optimal fit minimizes the randomness of the location of vacant seats in the travel conveyance attempting to maintain large vacancy areas in the travel conveyance for contiguity purposes.

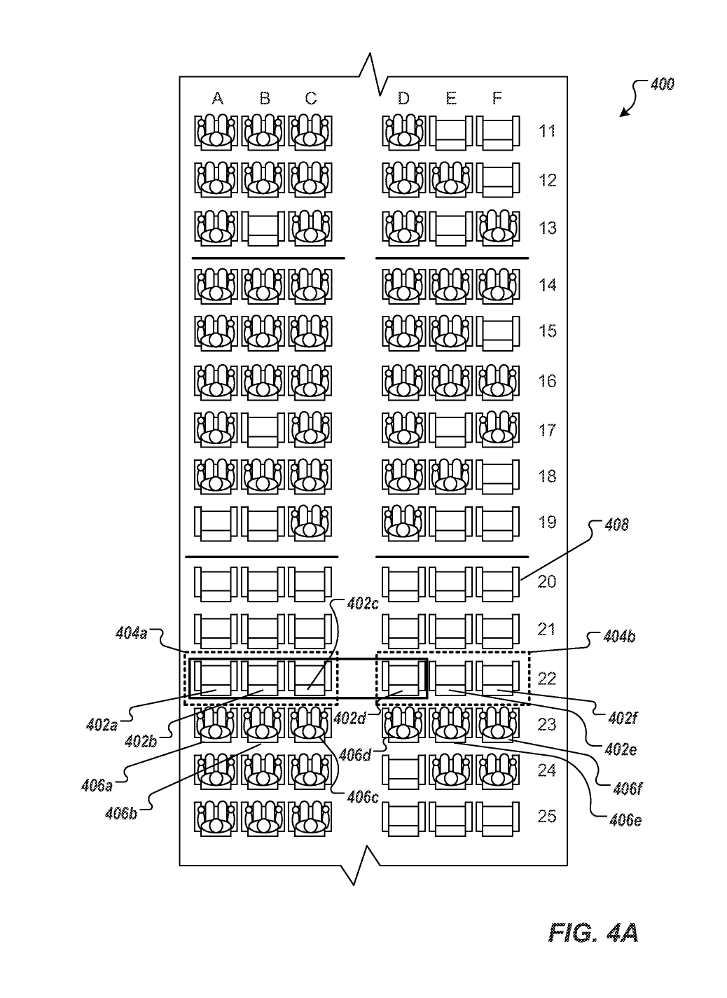

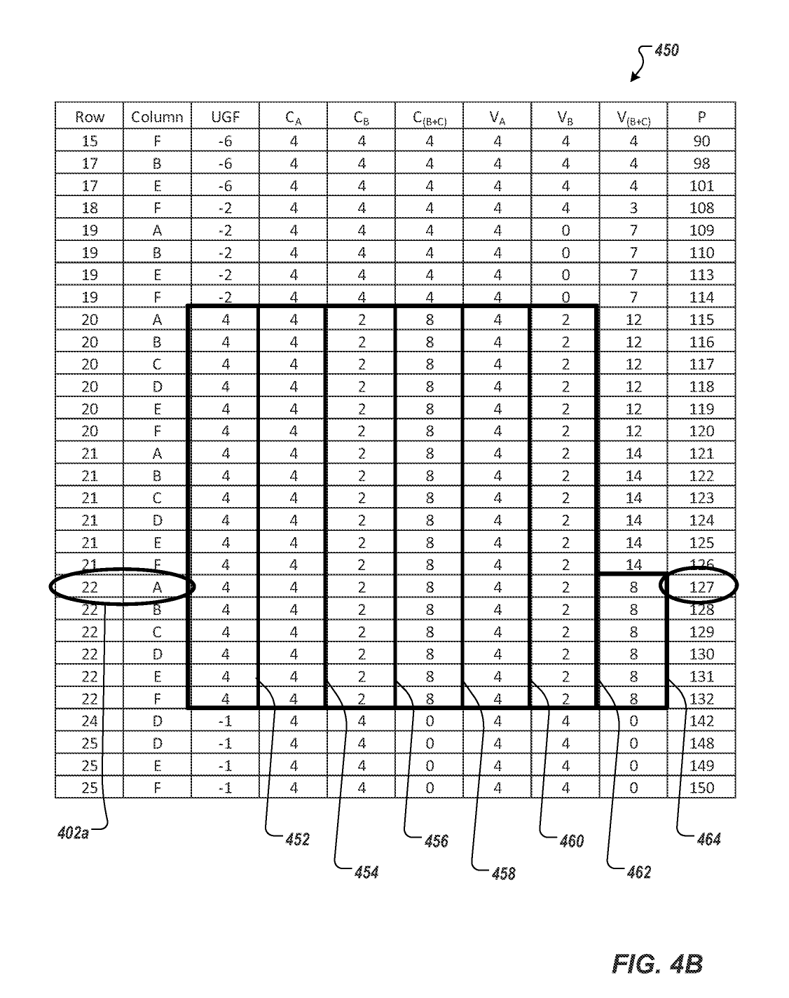

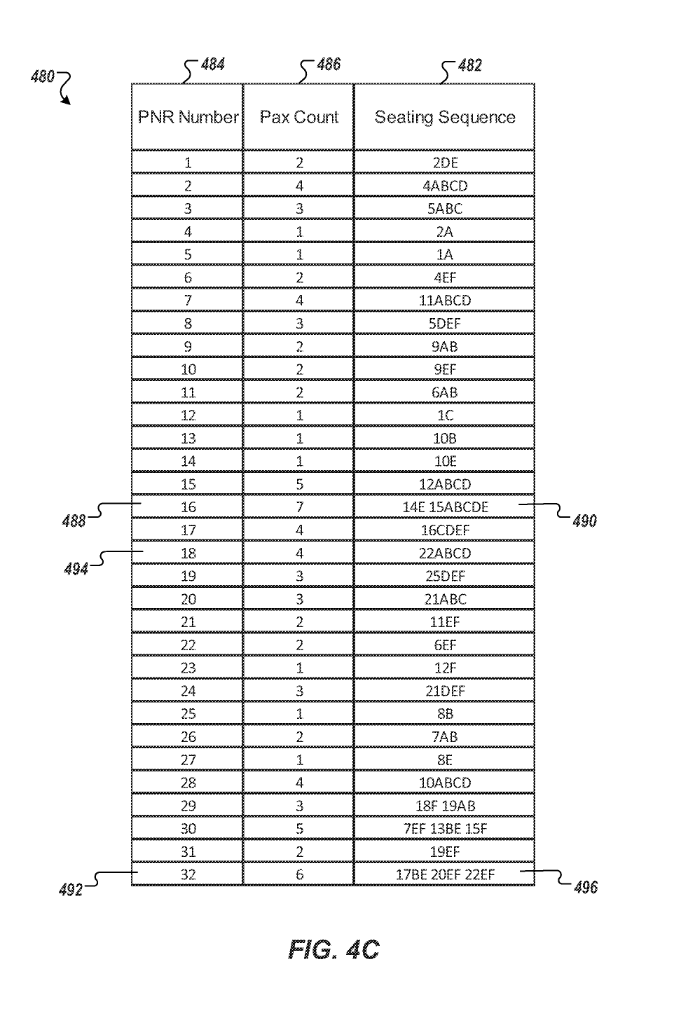

FIG. 4A is a diagram of an example seating plan 400 for a travel conveyance. The seating plan 400 shows a unit as a seat (e.g., seat 408) with contiguous units (e.g., seats 402a-c and seats 402d-f) each comprising a seat set (e.g., seat sets 404a and 404b, respectively) and seats 402a-f comprising a row (e.g., row 22). The example seating plan 400 illustrates a seat set that includes three adjacent seats and a row that includes six seats. Seats without a passenger icon are deemed to be un-assigned seats (i.e., available for a seat request) and seats with a passenger icon are deemed to be already assigned seats (i.e., unavailable for a seat request). In the depicted example, seats 402a-f are shown as unoccupied and available for selection by a seat assignment algorithm. In the depicted example, seats 406a-f are shown as occupied and not available for selection by the seat assignment algorithm. Seats 402a-f are located in row 22 of the travel conveyance and in columns A-F, respectively, of the travel conveyance. In the example seating plan 400, seats located in rows 20 to 25, rows 14 to 19, and rows 8 to 13 can be considered seat groups (e.g., seat group 10, seat group 11, and seat group 12), respectively. Other additional seats groups, not shown, may also be included in the travel conveyance. In the example seating plan 400, the lower the row number of a seat the more desirable the seat. In the example seating plan 400, the higher the seat group number the more desirable the seats are that are included in the seat group.

In a non-limiting example of a seat selection process using the example seating plan 400, a seat assignment algorithm receives a seat request for four seats for a PNR that includes four passengers (i.e., PAX=4): passenger_A, passenger_B, passenger_C, and passenger_D. Passenger_A is performing the booking and indicates a seating preference for a window seat. The seat assignment algorithm determines that the PNR-associated passengers are eligible to sit within a seat provided in one of seat groups 10 and 11. The seat assignment algorithm defines an initial set of seats as seats 15F, 17B, 17E, 18F, 19A-B and 19E-F included in seat group 11 and seats 20A-F, 21A-F, 22A-F, 24C, and 25C-F included in seat group 10 (i.e., the occupied seats of seat groups 10 and 11 are not included). The seat assignment algorithm calculates UGF, contiguity and vacancy factors for each of the seats in the initial set of seats.

FIG. 4B depicts an example chart 450 showing UGF, PF, contiguity factors and vacancy factors for the seats in the initial set of seats. More particularly, and as discussed above, the seat assignment algorithm identifies the initial set of seats as including seats 15F, 17B, 17E, 18F, 19A-B, 19E-F, 20A-F, 21A-F, 22A-F, 24C and 25C-F (i.e., n=30). In this example, it can be determined that the UGF is to be used in identifying the anchor seat (see (214) of FIG. 2A), as opposed to PF. In the example chart 450, the maximum UGF is equal to 4 and multiple seats include the maximum UGF. Consequently, there is not a single, maximum UGF in the initial set of seats, and UGF is not the criteria used to select the anchor seat. However, a second set of seats 452 is defined and includes seats 20A-F, 21A-F and 22A-F (i.e., p=18). The second set of seats 452 includes less seats than the initial set of seats.

Continuing with the example chart 450, C_{A} is next considered for the second set of seats 452. In the example chart 450, the minimum C_{A} is equal to 4 and all seats in the second set of seats 452 include the minimum C_{A}. Consequently, there is not a single, minimum C_{A} in the second set of seats 452, and C_{A} is not the criteria used to select the anchor seat. However, a third set of seats 454 can be defined and includes seats 20A-F, 21A-F and 22A-F. Consequently, the third set of seats is identical to the second set of seats (i.e., q=p=18). Continuing with the example chart 450, C_{B} is next considered for the third set of seats 454. In the example chart 450, the minimum C_{B} is equal to 2 and all seats in the third set of seats 454 include the minimum C_{B}. Consequently, there is not a single, minimum C_{B} in the third set of seats 454, and C_{B} is not the criteria used to select the anchor seat. However, a fourth set of seats 456 can be defined and includes seats 20A-F, 21A-F and 22A-F. Consequently, the fourth set of seats is identical to the third set of seats (i.e., r=q=18). Continuing with the example chart 450, C_{(B+C)} is next considered for the fourth set of seats 456. In the example chart 450, the minimum C_{(B+C)} is equal to 8 and all seats in the fourth set of seats 456 include the minimum C_{(B+C)}. Consequently, there is not a single, minimum C_{(B+C)} in the fourth set of seats 456, and C_{(B+C)} is not the criteria used to select the anchor seat. However, a fifth set of seats 458 can be defined and includes seats 20A-F, 21A-F and 22A-F. Consequently, the fifth set of seats is identical to the fourth set of seats (i.e., s=r=18).

Continuing with the example chart 450, V_{A} is next considered for the fifth set of seats 458. In the example chart 450, the minimum V_{A} is equal to 4 and all seats in the fifth set of seats 458 include the minimum V_{A}. Consequently, there is not a single, minimum V_{A} in the fifth set of seats 458, and V_{A} is not the criteria used to select the anchor seat. However, a sixth set of seats 460 can be defined and includes seats 20A-F, 21A-F and 22A-F. Consequently, the sixth set of seats is identical to the fifth set of seats (i.e., t=s=18). Continuing with the example chart 450, V_{B} is next considered for the sixth set of seats 460. In the example chart 450, the minimum V_{B} is equal to 2 and all seats in the sixth set of seats 460 include the minimum V_{B}. Consequently, there is not a single, minimum V_{B} in the sixth set of seats 460, and V_{B} is not the criteria used to select the anchor seat. However, a seventh set of seats 462 can be defined and includes seats 20A-F, 21A-F and 22A-F. Consequently, the seventh set of seats is identical to the sixth set of seats (i.e., u=t=18). Continuing with the example chart 450, V_{(B+C)} is next considered for the seventh set of seats 462. In the example chart 450, the minimum V_{(B+C)} is equal to 8 and a subset of seats in the seventh set of seats 462 include the minimum V_{(B+C)}. Consequently, there is not a single, minimum V_{(B+C)} in the seventh set of seats 462, and V_{(B+C)} is not the criteria used to select the anchor seat. However, an eighth set of seats 464 can be defined and includes seats 22A-F. Consequently, the eighth set of seats includes less seats than the seventh set of seats (i.e., u>w=6).

Continuing with the example chart 450, P is next considered for the eighth set of seats 464. In the example chart 450, the minimum P is equal to 127 and only one seat, namely seat 22A, includes the minimum P. Consequently, there is a single, minimum P in the eighth set of seats 464, and P is the criteria used to select the anchor seat. In the example case, seat 22A (seat 402a in FIG. 4A) is selected as the anchor seat for the subject PNR.

Referring again to FIG. 4A, after the anchor seat (seat 402a) is selected, the anchor seat can be assigned to a passenger in the PNR and the remaining passengers in the PNR can be assigned seats based on the anchor seat. In some examples, the seat assignment algorithm assigns seat 22A (402a) to passenger_A, and proceeds to assign contiguous seats to the remaining passengers included in the PNR (i.e., passenger_B, passenger_C, and passenger_D, in the non-limiting example). The seat assignment algorithm assigns seat 22B (seat 402b) to passenger_B, seat 22C (seat 402c) to passenger_C, and seat 22D (seat 402d) to passenger_D. As illustrated by this example, the contiguous seating of the four PNR-associated passengers took precedence over the seating of the passengers in seats in a higher numbered seat group. Though in this example, seats 19A, 19B, 19E, and 19F would allow four passengers to sit in the same row in seats considered more desirable than seats 22A-D (seats 19A, 19B, 19E, and 19F are in seat group 11 and seats 22A-D are in seat group 10), the passengers would be separated by two seats, seat 19C and seat 19D, that are occupied by other passengers. Seats 22A-D place the four passengers in contiguous seats. In this example, contiguity trumps seat group.

The seat assignment algorithm also selected seats 22A-D based on optimal fit. Though row 20 and row 21 each include four contiguous seats with a window seat as a potential anchor seat (seats 20A-D and seats 21A-D, respectively) the seating of the four PNR-associated passengers in seats 22A-D maintains a vacant area of seats in the travel conveyance (seats 19A-B, seats 19E-F, seats 20A-F, and seats 21A-F), while leaving a minimum number of vacant seats (seats 22E-F). In determining the optimal fit, the seat assignment algorithm “magnets” to the lower area of seat group 10, which has the most number of occupied seats, in order to preserve the contiguity of rows 19, 20 and 21. In this example, vacancy trumps seat group. Though seats 20A-D may be considered more desirable seats as they are the lower numbered seats in the seat group, in order to achieve an optimal fit on the row vacancy level, the seat assignment algorithm assigned seats 22A-D to the four PNR-associated passengers.

FIG. 4C is an example chart 480 of assigned seats for passengers included in passenger name records (PNRs). The chart 480 shows the seat assignment sequence 482 for each PNR number 484 and the number of PNR-associated passengers (pax count) 486 for each PNR number 484. PNR number 494 (PNR 18) is the PNR described in FIG. 4A and FIG. 4B.

For example, the PNR numbers can be indicative of the order of receipt of a booking, the bookings for the lower numbered PNRs received before the bookings for the higher number PNRs. As the seating assignments are performed for each booking, the number of occupied seats increases, the number of unoccupied seats decreases, and the seat assignment algorithm has fewer seats for seat assignment for the next PNR. However, the seat assignment algorithm can identify the optimum contiguous seats based on the number of occupied seats on the travel conveyance. For example, seven passengers included in PNR number 488 (PNR 16) are seated contiguously in seats 14EF and 15ABCDE (sequence 490). Six passengers included in PNR number 492 (PNR 32) are seated contiguously in multiple non-contiguous rows in seats 17B, 17E, 20EF, and 22EF (sequence 496) dependent on the reduced number of available seats. The seat assignment algorithm seats the passengers in PNR number 492 as contiguously and as close as possible dependent on the available seats on the travel conveyance.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations and all of the functional operations described in this specification may be realized in digital electronic circuitry, or in computer software, firmware, or hardware, including the structures disclosed in this specification and their structural equivalents, or in combinations of one or more of them. Implementations may be provided using one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be provided on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be provided in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be provided in combination in a single implementation. Conversely, various features that are described in the context of a single implementation may also be provided in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations have been described. Other implementations are within the scope of the following claims. For example, the actions recited in the claims may be performed in a different order and still achieve desirable results.

What is claimed is:

1. A computer-implemented method executed using one or more processors, the method comprising:
receiving a seat request, the seat request requesting a plurality of seats, each seat comprising a seat on a travel conveyance;
in response to receiving the seat request, calculating factors associated with each seat in a set of eligible seats;
defining an initial set of seats as a subset of the set of eligible seats, a set of factors being associated with each seat in the initial set of seats to provide a plurality of factor sets, a priority being associated with the plurality of factor sets, the factors comprising a plurality of contiguity factors and a plurality of vacancy factors, contiguity factors being of a higher priority than vacancy factors;
processing factors of the plurality of factor sets based on the priority to identify an anchor seat from the initial set of seats; and
assigning the plurality of seats of the seat request based on the anchor seat.

2. The method of claim 1, wherein calculating factors comprises calculating a unit group factor for each of the eligible seats in the set of eligible seats to provide a set of unit group factors.

3. The method of claim 2, wherein the anchor seat is identified based on the set of unit group factors.

4. The method of claim 3, wherein the anchor seat is identified as a seat associated with a maximum unit group factor in the set of unit group factors.

5. The method of claim 1, wherein the plurality of contiguity factors comprises a hierarchy and the anchor seat is identified based on the plurality of contiguity factors.

6. The method of claim 1, wherein a contiguity factor of the plurality of contiguity factors is associated with a number of contiguous sets in a seat set.

7. The method of claim 1, wherein a contiguity factor of the plurality of contiguity factors is associated with a number of contiguous units in a row of seats.

8. The method of claim 7, wherein the contiguity factor is further associated with a number of contiguous seats in adjacent rows of seats.

9. The method of claim 1, wherein the plurality of vacancy factors comprises a hierarchy and the anchor seat is identified based on the plurality of vacancy factors.

10. The method of claim 1, wherein a vacancy factor of the plurality of vacancy factors is associated with a number of vacant seats in a seat set.

11. The method of claim 1, wherein a vacancy factor of the plurality of vacancy factors is associated with a number of vacant seats in a row of seats.

12. The method of claim 1, wherein the vacancy factor is further associated with a number of vacant seats in adjacent rows of seats.

13. The method of claim 1, wherein processing the factors comprises processing factor sets in an order defined by the priority of the factor sets.

14. The method of claim 1, wherein processing factors of the plurality of factor sets based on the priority to identify an anchor seat from the initial set of seats comprises processing the plurality of contiguity factors in a hierarchical order, and processing the plurality of vacancy factors in a hierarchical order.

15. The method of claim 1, wherein calculating one or more factors comprises calculating a priority factor for each of the seat in the set of eligible seats to provide a plurality of priority factors.

16. The method of claim 15, wherein the anchor seat is identified based on the plurality of priority factors.

17. The method of claim 1, wherein processing factors of the plurality of factor sets to identify the anchor seat comprises defining one or more subsequent sets of seats, each of the one or more subsequent sets of seats being a subset of the initial set of seats, and identifying the anchor seat from one of the one or more subsequent sets of seats.

18. The method of claim 1, wherein the travel conveyance comprises one of an airplane, a train, a bus and a ship.

19. A system, the system comprising:
one or more computers; and
a computer-readable medium coupled to the one or more computers having instructions stored thereon which, when executed by the one or more computers, cause the one or more computers to perform operations comprising:
receiving a seat request, the seat request requesting a plurality of seats, each seat comprising a seat on a travel conveyance;
in response to receiving the seat request, calculating factors associated with each seat in a set of eligible seats;
defining an initial set of seats as a subset of the set of eligible seats, a set of factors being associated with each seat in the initial set of seats to provide a plurality of factor sets, a priority being associated with the plurality of factor sets, the factors comprising a plurality of contiguity factors and a plurality of vacancy factors, contiguity factors being of a higher priority than vacancy factors;
processing factors of the plurality of factor sets based on the priority to identify an anchor seat from the initial set of seats; and
assigning the plurality of seats of the seat request based on the anchor seat.

20. The system of claim 19, wherein the operations further comprise calculating factors comprises calculating a unit group factor for each of the eligible seats in the set of eligible seats to provide a set of unit group factors.

21. The system of claim 20, wherein the anchor seat is identified based on the set of unit group factors.

22. The system of claim 21, wherein the anchor seat is identified as a seat associated with a maximum unit group factor in the set of unit group factors.

23. The system of claim 19, wherein the plurality of contiguity factors comprises a hierarchy and the anchor seat is identified based on the plurality of contiguity factors.

24. The system of claim 19, wherein a contiguity factor of the plurality of contiguity factors is associated with a number of contiguous sets in a seat set.

25. The system of claim 19, wherein a contiguity factor of the plurality of contiguity factors is associated with a number of contiguous units in a row of seats.

26. The system of claim 25, wherein the contiguity factor is further associated with a number of contiguous seats in adjacent rows of seats.

27. The system of claim 19, wherein the plurality of vacancy factors comprises a hierarchy and the anchor seat is identified based on the plurality of vacancy factors.

28. The system of claim 19, wherein a vacancy factor of the plurality of vacancy factors is associated with a number of vacant seats in a seat set.

29. The system of claim 19, wherein a vacancy factor of the plurality of vacancy factors is associated with a number of vacant seats in a row of seats.

30. The system of claim 19, wherein the vacancy factor is further associated with a number of vacant seats in adjacent rows of seats.

31. The system of claim 19, wherein processing the factors comprises processing factor sets in an order defined by the priority of the factor sets.

32. The system of claim 19, wherein the operation of processing factors of the plurality of factor sets based on the priority to identify an anchor seat from the initial set of seats comprises processing the plurality of contiguity factors in a hierarchical order, and processing the plurality of vacancy factors in a hierarchical order.

33. The system of claim 19, wherein the operation of calculating one or more factors comprises calculating a priority factor for each of the seat in the set of eligible seats to provide a plurality of priority factors.

34. The system of claim 33, wherein the anchor seat is identified based on the plurality of priority factors.

35. The system of claim 19, wherein the operation of processing factors of the plurality of factor sets to identify the anchor seat comprises defining one or more subsequent sets of seats, each of the one or more subsequent sets of seats being a subset of the initial set of seats, and identifying the anchor seat from one of the one or more subsequent sets of seats.

36. The system of claim 19, wherein the travel conveyance comprises one of an airplane, a train, a bus and a ship.

37. A computer storage medium encoded with a computer program, the computer program comprising instructions that when executed by one or more processors cause the one or more processors to perform operations comprising:
receiving a seat request, the seat request requesting a plurality of seats, each seat comprising a seat on a travel conveyance;
in response to receiving the seat request, calculating factors associated with each seat in a set of eligible seats;
defining an initial set of seats as a subset of the set of eligible seats, a set of factors being associated with each seat in the initial set of seats to provide a plurality of factor sets, a priority being associated with the plurality of factor sets, the factors comprising a plurality of contiguity factors and a plurality of vacancy factors, contiguity factors being of a higher priority than vacancy factors;
processing factors of the plurality of factor sets based on the priority to identify an anchor seat from the initial set of seats; and
assigning the plurality of seats of the seat request based on the anchor seat.

38. The computer storage medium of claim 37, wherein the operations further comprise calculating factors comprises calculating a unit group factor for each of the eligible seats in the set of eligible seats to provide a set of unit group factors.

39. The computer storage medium of claim 38, wherein the anchor seat is identified based on the set of unit group factors.

40. The computer storage medium of claim 39, wherein the anchor seat is identified as a seat associated with a maximum unit group factor in the set of unit group factors.

41. The computer storage medium of claim 37, wherein the plurality of contiguity factors comprises a hierarchy and the anchor seat is identified based on the plurality of contiguity factors.

42. The computer storage medium of claim 37, wherein a contiguity factor of the plurality of contiguity factors is associated with a number of contiguous sets in a seat set.

43. The computer storage medium of claim 37, wherein a contiguity factor of the plurality of contiguity factors is associated with a number of contiguous units in a row of seats.

44. The computer storage medium of claim 43, wherein the contiguity factor is further associated with a number of contiguous seats in adjacent rows of seats.

45. The computer storage medium of claim 37, wherein the plurality of vacancy factors comprises a hierarchy and the anchor seat is identified based on the plurality of vacancy factors.

46. The computer storage medium of claim 37, wherein a vacancy factor of the plurality of vacancy factors is associated with a number of vacant seats in a seat set.

47. The computer storage medium of claim 37, wherein a vacancy factor of the plurality of vacancy factors is associated with a number of vacant seats in a row of seats.

48. The computer storage medium of claim 37, wherein the vacancy factor is further associated with a number of vacant seats in adjacent rows of seats.

49. The computer storage medium of claim 37, wherein processing the factors comprises processing factor sets in an order defined by the priority of the factor sets.

50. The computer storage medium of claim 37, wherein the operation of processing factors of the plurality of factor sets based on the priority to identify an anchor seat from the initial set of seats comprises processing the plurality of contiguity factors in a hierarchical order, and processing the plurality of vacancy factors in a hierarchical order.

51. The computer storage medium of claim 37, wherein the operation of calculating one or more factors comprises calculating a priority factor for each of the seat in the set of eligible seats to provide a plurality of priority factors.

52. The computer storage medium of claim 51, wherein the anchor seat is identified based on the plurality of priority factors.

53. The computer storage medium of claim 37, wherein the operation of processing factors of the plurality of factor sets to identify the anchor seat comprises defining one or more subsequent sets of seats, each of the one or more subsequent sets of seats being a subset of the initial set of seats, and identifying the anchor seat from one of the one or more subsequent sets of seats.

54. The computer storage medium of claim 37, wherein the travel conveyance comprises one of an airplane, a train, a bus and a ship.
